(19) United States
(12) Patent Application Publication
(10) Pub. No.: US 2018/0040010 A1
(43) Pub. Date: Feb. 8, 2018

(54) GROUPING SYSTEM, METHOD AND PROGRAM

(71) Applicant: NEC Corporation, Tokyo (JP)

(72) Inventors: Shinji NAKADAI, Tokyo (JP); Koutarou OCHIAI, Tokyo (JP); Takayuki TERAKAWA, Tokyo (JP)

(73) Assignee: NEC Corporation, Tokyo (JP)

(21) Appl. No.: 15/552,145

(22) PCT Filed: Feb. 2, 2016
(86) PCT No.: PCT/JP2016/000532

§ 371 Date: Aug. 18, 2017

(30) Foreign Application Priority Data
Feb. 23, 2015 (JP) 2015-032841

(51) Int. Cl. G06Q 30/02

(52) U.S. Cl. CPC G06Q 30/0204

(57) ABSTRACT

Provided is a grouping system capable of grouping customers and options in each channel, considering variation of behavior of each customer depending on the channel. A grouping means 3 uses a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

### TECHNICAL FIELD

The present invention relates to a grouping system, a grouping method, and a grouping program that group customers together and group options of an activity for a customer together, and relates to a sales aspect determination system, a sales aspect determination method, and a sales aspect determination program that determine a sales aspect of a product, and relates to an event invitation aspect determination system, an event invitation aspect determination method, and an event invitation aspect determination program that determine an event invitation aspect.

### BACKGROUND ART

An aspect in which a customer selects an option of an activity is referred to as a channel. Typical examples of the option of the activity include various products selected by the customer in a customer's purchasing activity. Hereinafter, a case will be described where the option of the activity is a product, as an example; however, the option of the activity is not limited to the product.

Examples of the channel include various channels, for example, “a customer selects and purchases a product at a convenience store.”, “a customer selects and purchases a product at a department store.”, “a customer selects and purchases a product at a supermarket.”, and “a customer selects and purchases a product at an online store.”. Each of these channels can be said to be a channel depending on a store type.

In addition, other examples of the channel include various channels, for example, “a customer who receives product information via direct mail purchases the product.”, “a customer who receives product information via e-mail purchases the product.”, and “a customer who browses product information on a Web page purchases the product”. Each of these channels can be said to be a channel depending on an information type of options. Incidentally, when there is no fact of purchasing by the customer, the channel depending on the information type of options does not correspond to the channel. For example, when the customer receives product information via direct mail but does not purchase the product, it does not correspond to the channel “a customer who receives product information via direct mail purchases the product.”.

Even when it is the channel depending on the store type, or the channel depending on the information type of options, it can be said to be an aspect in which the customer selects an option such as a product. The fact that one company has a sales channel by a plurality of channels is referred to as a multi-channel or an omni-channel.

Examples of general technologies for preference analysis in product purchasing include collaborative filtering based on matrix decomposition. This technology is a technique for decomposing a matrix having customers as rows and products as columns into a matrix with a lower rank. The row after decomposition corresponds to a group of customers, and the column after decomposition corresponds to a group of products. The group of customers obtained as a result is determined to be a group of customers having similar preference regarding purchasing of products.

In addition, in PTL 1, it is described that a plurality of member IDs is associated with identification information of one mobile terminal by using that an identical person having the member IDs assigned from different retailers is assumed to purchase products at stores of the retailers.

In addition, in PTL 2, a recommendation device is described. The recommendation device described in PTL 2 stores a product having a feature matching the customer's preference, for each customer, and simultaneously stores a product purchased by a person similar to the customer, and transmits product information of a recommended product as recommendation information, for each customer.

### CITATION LIST

### Patent Literature

PTL 1: Japanese Patent Application Laid-Open No. 2014-44583

PTL 2: Japanese Patent Application Laid-Open No. 2012-234503

### SUMMARY OF INVENTION

### Technical Problem

It is conceivable to group customers and products together by the above collaborative filtering by using information that each of the customers in the plurality of channels has purchased various products. However, product selection behavior of each of the customers varies depending on the channel. For example, there are customers who shop at a convenience store but do not shop at a department store, and vice versa. In this way, since the product selection behavior of the customers varies depending on the channel, even when the customers and the products are grouped together as described above, only groups that are obviously obtained without using the collaborative filtering are obtained, such as “customers who use department stores”, “customers who use convenience stores”, “customers who use both department stores and convenience stores”, “products purchased at department stores”, “products purchased at convenience stores”, “products purchased at both department stores and convenience stores”.

In addition, even the same customer may take different selection behavior for the same product depending on the channel. For example, the customer may have different purchasing tendencies for a supermarket with a wide selection of products and a convenience store with a less selection of products, even for the same product.

In addition, it is preferable that grouping of customers and grouping of products in each channel are performed, and a sales aspect according to the group of customers is appropriately determined.

Similarly, it is preferable that grouping of customers and grouping of events in each channel are performed, and an invitation aspect to an event according to the group of customers is appropriately determined.

Therefore, an object of the present invention is to provide a grouping system, a grouping method, and a grouping program capable of solving a technical problem of making it possible to group customers and options in each channel, considering variation of behavior of each customer depending on the channel.

In addition, an object is to provide a sales aspect determination system, a sales aspect determination method, and a sales aspect determination program capable of solving a technical problem of making it possible to perform grouping of customers and grouping of products in each channel and appropriately determine a sales aspect according to the group of customers.

In addition, an object is to provide an event invitation aspect determination system, an event invitation aspect determination method, and an event invitation aspect determination program capable of solving a technical problem of making it possible to perform grouping of customers and grouping of events in each channel and appropriately determine an invitation aspect to an event according to the group of customers.

### Solution to Problem

A grouping system according to the present invention includes: an input means that inputs combinations of a customer, an option of an activity, and a history of the activity, obtained for each channel being an aspect in which the customer selects the option of the activity; and a grouping means that uses a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

In addition, a sales aspect determination system according to the present invention includes: an input means that inputs combinations of a customer, a product, and a history that the customer has purchased the product, obtained for each channel being an aspect in which a customer selects a product; a grouping means that classify customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to the input means; and a sales aspect determination means that determines different sales aspects for a sales aspect for the customer belonging to the first customer group and a sales aspect for the customer belonging to the second customer group, respectively.

In addition, an event invitation aspect determination system of the present invention includes: an input means that inputs combinations of a customer, an event, and a history that the customer has participated in the event, obtained for each channel being an aspect in which the customer selects the event; a grouping means that classify customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input means; and an event invitation aspect determination means that determines different event invitation aspects for an event invitation aspect for the customer belonging to the first customer group and an event invitation aspect for the customer belonging to the second customer group, respectively.

In addition, a grouping method grouping method according to the present invention includes: accepting an input of combinations of a customer, an option of an activity, and a history of the activity, obtained for each channel being an aspect in which the customer selects the option of the activity; and using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

In addition, a sales aspect determination method according to the present invention includes: accepting an input of combinations of a customer, a product, and a history that the customer has purchased the product, obtained for each channel being an aspect in which a customer selects a product; and classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination; and determining different sales aspects for a sales aspect for the customer belonging to the first customer group and a sales aspect for the customer belonging to the second customer group, respectively.

In addition, an event invitation aspect determination method according to the present invention includes: accepting an input of combinations of a customer, an event, and a history that the customer has participated in the event, obtained for each channel being an aspect in which the customer selects the event; classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination; and determining different event invitation aspects for an event invitation aspect for the customer belonging to the first customer group and an event invitation aspect for the customer belonging to the second customer group, respectively.

In addition, a grouping program according to the present invention is a grouping program installed in a computer including an input means that inputs combinations of a customer, an option of an activity, a history of the activity, obtained for each channel being an aspect in which the customer selects the option of the activity, and the grouping program causes the computer to execute: grouping processing for using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

In addition, a sales aspect determination program according to the present invention is a grouping program installed in a computer including an input means that inputs combinations of a customer, a product, and a history that the customer has purchased the product, obtained for each channel being an aspect in which a customer selects a product, and the sales aspect determination program causes the computer to execute: grouping processing for classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to an input means; and sales aspect determination processing for determining different sales aspects for a sales aspect for the customer belonging to the first customer group and a sales aspect for the customer belonging to the second customer group, respectively.

In addition, an event invitation aspect determination program according to the present invention is a grouping program installed in a computer including an input means that inputs combinations of a customer, an event, a history that the customer has participated in the event, obtained for each channel being an aspect in which the customer selects the event, and the event invitation aspect determination program causes the computer to execute: grouping processing for classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input means; and event invitation aspect determination processing for determining different event invitation aspects for an event invitation aspect for the customer belonging to the first customer group and an event invitation aspect for the customer belonging to the second customer group, respectively.

### Advantageous Effects of Invention

According to a technical means of the present invention, a technical effect is obtained of making it possible to group customers and options in each channel, considering variation of behavior of each customer depending on the channel.

In addition, according to a technical means of the present invention, a technical effect is obtained of making it possible to perform grouping of customers and grouping of products in each channel, to appropriately determine a sales aspect according to the group of customers.

In addition, according to a technical means of the present invention, a technical effect is obtained of making it possible to perform grouping of customers and grouping of events in each channel, to appropriately determine an invitation aspect to an event according to the group of customers.

### BRIEF DESCRIPTION OF DRAWINGS

FIG. 1 It depicts a block diagram illustrating an example of a grouping system of a first exemplary embodiment of the present invention.

FIGS. 2(A) to 2(B) They each depict an explanatory diagram illustrating an example of information input to an input means.

FIG. 3 It depicts a schematic diagram illustrating an example of a state in which a customer ID, a product ID in a first channel, and a product ID in a second channel before grouping are arranged in order.

FIG. 4 It depicts an explanatory diagram schematically illustrating examples of a customer group, a first product group, and a second product group determined by a grouping means.

FIG. 5 It depicts an explanatory diagram schematically illustrating a parameter θ^{c,ich1}.

FIG. 6 It depicts a flowchart illustrating an example of processing progress in the first exemplary embodiment of the present invention.

FIG. 7 It depicts a schematic diagram illustrating a situation in which a customer A and a customer B are classified in different customer groups, respectively.

FIG. 8 It depicts a block diagram illustrating an example of a grouping system of a second exemplary embodiment of the present invention.

FIG. 9 It depicts a schematic diagram illustrating a situation in which a sales aspect determination means determines a recommended product.

FIG. 10 It depicts a flowchart illustrating an example of processing progress in the second exemplary embodiment of the present invention.

FIG. 11 It depicts a schematic diagram illustrating a situation in which the sales aspect determination means determines a channel.

FIG. 12 It depicts a flowchart illustrating another example of processing progress in the second exemplary embodiment of the present invention.

FIG. 13 It depicts a block diagram illustrating an example of a grouping system in a third exemplary embodiment of the present invention.

FIG. 14 It depicts a schematic diagram illustrating a situation in which an event invitation aspect determination means determines a channel.

FIG. 15 It depicts a flowchart illustrating an example of processing progress in the third exemplary embodiment of the present invention.

FIG. 16 It depicts a schematic block diagram illustrating a configuration example of a computer according to each exemplary embodiment of the present invention.

### DESCRIPTION OF EMBODIMENTS

Hereinafter, exemplary embodiments of the present invention will be described with reference to the drawings. In the following description, a case will be described where options of an activity for a customer are various products selected by the customer in a customer's purchasing activity, as an example. However, in the present invention, the options of the activity for the customer do not have to be the products. For example, the options of the activity may be various services selected by the customer in the customer's purchasing activity.

### First Exemplary Embodiment

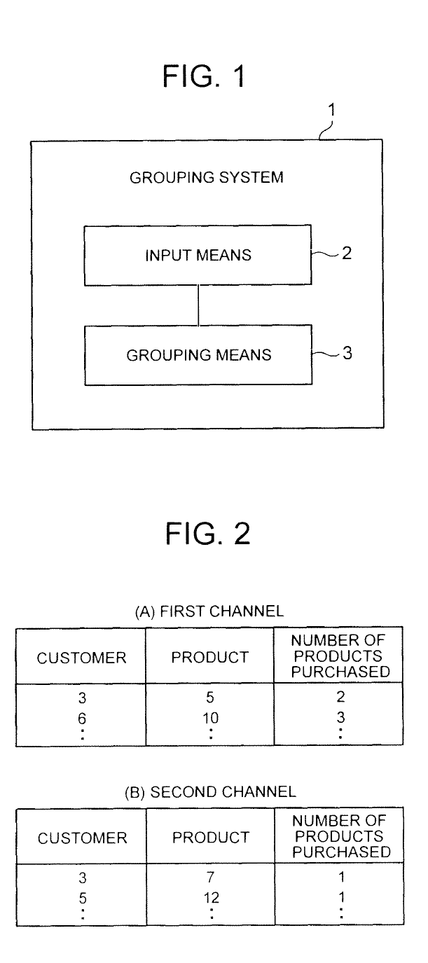

FIG. 1 depicts a block diagram illustrating an example of a grouping system of a first exemplary embodiment of the present invention. A grouping system 1 of the first exemplary embodiment includes an input means 2 and a grouping means 3.

The input means 2 is an input device that inputs combinations of a customer, a product (option of the customer's purchasing activity), and a history of an activity (in the exemplary embodiment, a purchasing activity) obtained for each channel.

FIGS. 2(A) to 2(B) each depict an explanatory diagram illustrating an example of information input to the input means 2. FIG. 2(A) exemplifies a relationship among the customer, the product, and the number of products purchased obtained for a first channel, and FIG. 2(B) exemplifies a relationship among the customer, the product, and the number of products purchased obtained for a second channel. The input means 2 inputs the information exemplified in FIGS. 2(A) to 2(B). The number indicated as information of the customer is identification information for identifying the customer (customer ID), and the number indicated as information of the product is identification information for identifying the product (product ID). For example, the first information in FIG. 2(A) means that the customer “3” has purchased two products “5”.

The number of products purchased indicated in FIGS. 2(A) to 2(B) corresponds to the history of the purchasing activity. Information indicating the history of the purchasing activity is not limited to the number of products purchased, and may be a purchasing amount of money or price elasticity, for example. It is assumed that Information calculated from each purchasing fact, such as the price elasticity, also corresponds to the information indicating the history of the purchasing activity. In addition, the information indicating the history of the purchasing activity may be different between the first channel and the second channel. For example, for the first channel, the information indicating a correspondence among the customer, the product, and the number of products purchased may be input, and for the second channel, the information indicating a correspondence among the customer, the product, and the purchasing amount of money may be input.

FIGS. 2(A) to 2(B) each illustrate a relationship among three attributes of the “customer”, the “product”, and the “number of products purchased”. Information of at least one attribute of these attributes is input to the input means 2 in any channel. For example, for the second channel, even when information indicating the “service” and the “purchasing amount of money” is input instead of the “product” and the “number of products purchased”, information indicating the “customer” input for the first channel is also input for the second channel. That is, the information indicating the “customer” is input in any channel. In this case, since information indicating a relationship in the first channel and information indicating a relationship in the second channel related to the “customer” are input to the input means 2, it can be said that multi-relationship information related to the “customer” is input to the input means 2.

In addition, the first channel and the second channel are channels provided by one company having a sales channel via a plurality of channels. For example, the first channel and the second channel are provided by a company managing a convenience store and a supermarket. In this case, the first channel may be a channel “a customer selects and purchases a product at a convenience store.”, and the second channel may be a channel “a customer selects and purchases a product at a supermarket.”.

In the following description, a case will be described where the first channel is a channel “a customer selects and purchases a product at a convenience store.”, and the second channel is a channel, “a customer selects and purchases a product at a supermarket.”, as an example. However, the first channel and the second channel are not limited to this example. In addition, in this example, both the first channel and the second channel correspond to the channel depending on the store type; however, each channel may be any of the channel depending on the store type and the channel depending on the information type of options. For example, both the first channel and the second channel may be the channels depending on the information type of options. In addition, for example, one channel may be the channel depending on the store type, and the other channel may be the channel depending on the information type of options.

In addition, FIGS. 2(A) to 2(B) illustrate a case where there are two channels; however, the number of channels may be three or more.

In addition, when customer IDs of the same customer are different between the first channel and the second channel, an administrator of the grouping system of the present invention (hereinafter, simply referred to as an administrator) only needs to replace a customer ID used in one channel with a customer ID used in the other channel, based on a customer master, and then input the information exemplified in FIGS. 2(A) to 2(B) to the input means 2. Hereinafter, a description will be made assuming that this processing is performed and the customer IDs of the same customer are common between the first channel and the second channel. Incidentally, this processing may be executed by the grouping means 3. In this case, the administrator only needs to also input the customer master to the input means 2.

In addition, product IDs of the same product may be common between the first channel and the second channel, or may be different. The grouping means 3 may replace a grouped product ID with a specific product (product name). In this case, to replace the product ID with the specific product name, the administrator only needs to also input the product master to the input means 2.

The grouping means 3 determines a group of customers, a group of products in the first channel, and a group of products in the second channel, based on the information input to the input means 2.

The customer ID is represented by a reference sign c. In addition, the product ID in the first channel is represented by a reference sign i^{ch1}, and the product ID in the second channel is represented by a reference sign i^{ch2}.

In addition, a customer with a customer ID “c” is referred to as a customer “c”. A product with a product ID “i^{ch1}” is referred to as a product “i^{ch1}”, and a product with a product ID “i^{ch2}” is referred to as a product “i^{ch2}”.

In addition, a history of the purchasing activity associated with the customer “c” and the product “i^{ch1}” (in the example illustrated in FIGS. 2(A) to 2(B), the number of products purchased) is referred to as x_{c,ich1}. For example, regarding the first information in FIG. 2(A), x_{3,5}=2. Similarly, a history of the purchasing activity associated with the customer “c” and the product “i^{ch2}” (in the example illustrated in FIGS. 2(A) to 2(B), the number of products purchased) is referred to as x_{c,ich2}. For example, regarding the first information in FIG. 2(B), x_{3,7}=1. Hereinafter, a case will be described where x_{c,ich1}, x_{c,ich2} each are the number of products purchased, as an example.

Hereinafter, to simplify the description, a case will be described where the grouping means 3 determines a group so that each of the customers (in other words, each of the customer IDs) belongs to only one group, each of the products (in other words, each of the product IDs) in the first channel belongs to only one group, and each of the products (in other words, each of the product IDs) in the second channel belongs to only one group, as an example. Incidentally, determining a group so that one element belongs to only one group in this way is referred to as clustering.

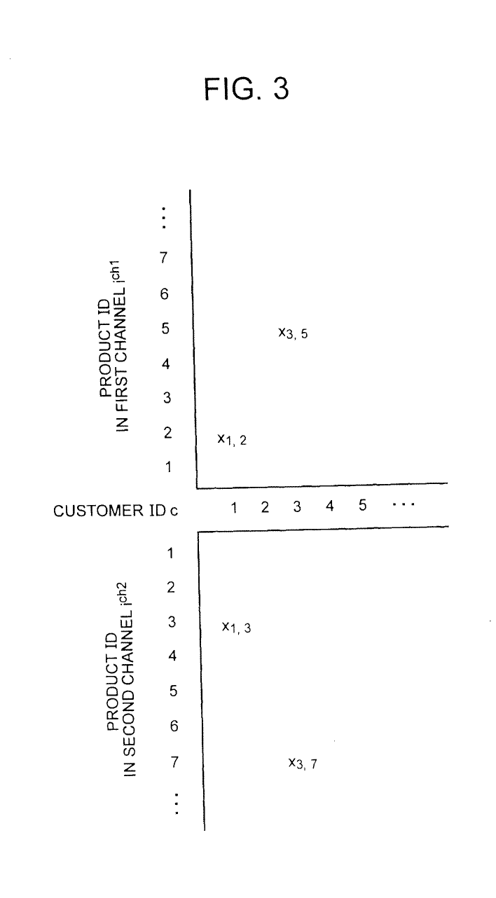

The grouping means 3 performs grouping simultaneously for the customer, the product in the first channel, and the product in the second channel. FIG. 3 depicts a state in which the customer ID, the product ID in the first channel, and the product ID in the second channel before grouping are arranged in order. FIG. 3 illustrates a relationship between the customer ID and the product ID in the first channel, in the upper half, and illustrates a relationship between the customer ID and the product ID in the second channel, in the lower half. In addition, FIG. 3 illustrates a state in which the customer IDs are arranged in order in the horizontal axis direction, and the product IDs in the first channel and the product IDs in the second channel are arranged in order in the vertical direction. The number of products purchased x_{c,ich1} in the first channel corresponds to a pair of one customer ID and one product ID in the first channel. For example, the number of products purchased x_{1,2} illustrated in the upper side in FIG. 3 corresponds to a pair of the customer ID “1” and the product ID “2” in the first channel. Similarly, the number of products purchased x_{c,ich2} in the second channel corresponds to a pair of one customer ID and one product ID in the second channel. For example, the number of products purchased x_{1,3} illustrated in the lower side in FIG. 3 corresponds to a pair of the customer ID “1” and the product ID “3” in the second channel. Incidentally, when a customer has not purchased a product, a history corresponding to the customer and the product does not exist.

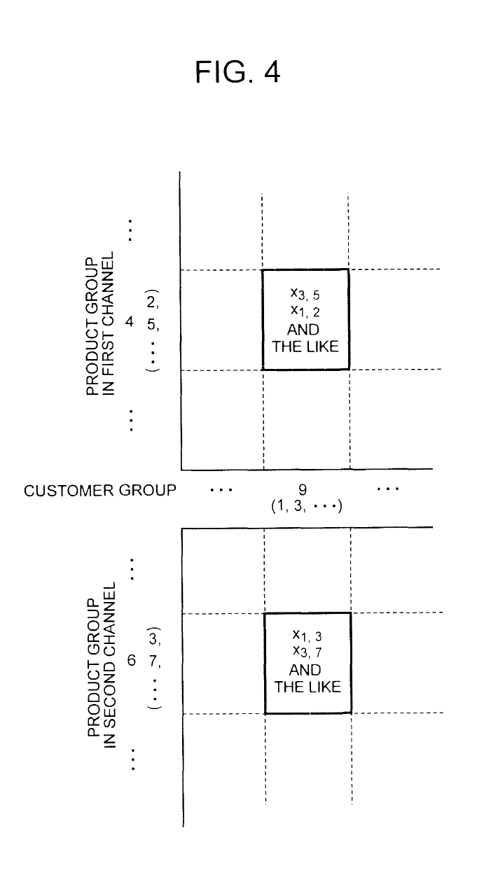

FIG. 4 depicts an explanatory diagram schematically illustrating examples of the customer group, the group of products in the first channel (hereinafter, referred to as first product group), and the group of products in the second channel (hereinafter, referred to as second product group) determined by the grouping means 3. A plurality of customer groups, first product groups and second product groups are respectively determined. However, in FIG. 4, to simplify the description, only the customer group with ID “9” is illustrated, only the first product group with ID “4” is illustrated, and only the second product group with ID “6” is illustrated. The number of customer groups, the number of first product groups, and the number of second product groups may be respectively determined to fixed values, or do not have to be limited to fixed values. It is assumed that the number of customer groups is K^{c}, and IDs of the customer groups are 1 to K^{c}. Similarly, it is assumed that the number of first product groups is K^{ich1}, and IDs of the first product groups are 1 to K^{ich1}. Similarly, it is assumed that the number of second product groups is K^{ich2}, and IDs of the second product groups are 1 to K^{ich2}. In addition, when the ID of a customer group is “a (a is any of 1 to K^{c})”, the customer group is referred to as a customer group “a”. The same applies to the first product group and the second product group.

In addition, in FIG. 4, the customer ID and the product ID belonging to the respective groups are indicated in parentheses. For example, the customer IDs “1”, “3”, and the like belong to the customer group “9”. The product IDs “2”, “5”, and the like in the first channel belong to the first product group “4”. The product IDs “3”, “7”, and the like in the second channel belong to the second product group “6”. The number of elements (customer IDs) belonging to one customer group is not particularly limited. This point also applies to the first product group and the second product group.

A combination of one customer group and one first product group corresponds to the number of products purchased x_{c,ich1} according to a combination of a customer ID belonging to the customer group and a product ID belonging to the first product group. For example, in the example illustrated in FIG. 4, the combination of the customer group “9” and the first product group “4” corresponds to x_{1,2}, x_{3,5}, and the like. Similarly, a combination of one customer group and one second product group corresponds to the number of products purchased x_{c,ich2} according to a combination of a customer ID belonging to the customer group and a product ID belonging to the second product group. For example, in the example illustrated in FIG. 4, the combination of the customer group “9” and the second product group “6” corresponds to x_{1,3}, x_{3,7}, and the like.

Incidentally, it can be said that FIG. 4 is a diagram modified from FIG. 3 so that customer IDs belonging to the same customer group are continuously arranged, and product IDs in the first channel belonging to the same first product group are continuously arranged, and product IDs in the second channel belonging to the same second product group are continuously arranged.

The grouping means 3 uses a likelihood of the customer group, the first product group, and the second product group, to determine the customer group, the first product group, and the second product group.

Here, a distribution parameter of x_{c,ich1} according to a combination of the customer group and the first product group (referred to as θ^{c,ich1}), and a distribution parameter of x_{c,ich2} according to a combination of the customer group and the second product group (referred to as θ^{c,ich2}) will be described. The distribution parameter θ^{c,ich1} Of x_{c,ich1} according to the combination of each customer group and each first product group, and the distribution parameter θ^{c,ich2} of x_{c,ich2} according to the combination of each customer group and each second product group are determined in advance. Hereinafter, the parameter θ^{c,ich1} will be described as an example.

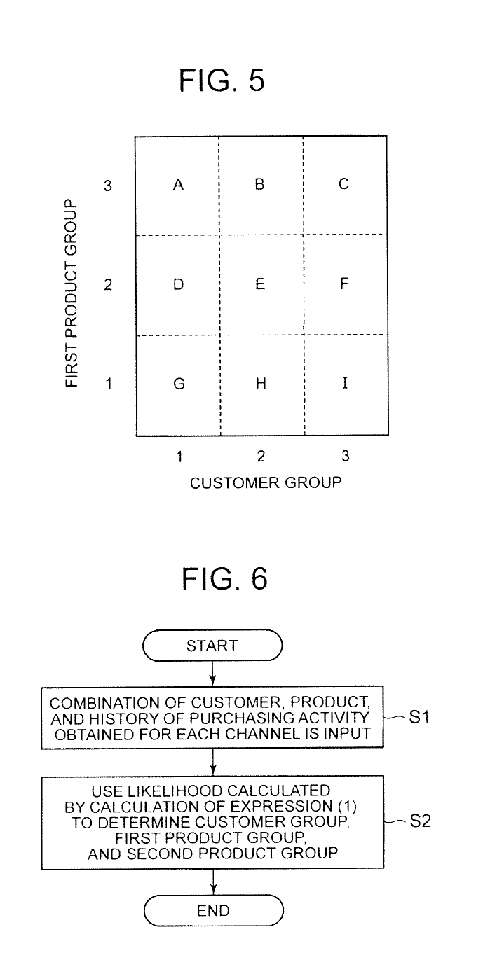

FIG. 5 depicts an explanatory diagram schematically illustrating the parameter θ^{c,ich1}. In FIG. 5, to simplify the description, a case is exemplified where each of the number of customer groups and the number of first product groups is three. For each combination of one customer group and one product group in the first channel, the distribution parameter of x_{c,ich1} according to the combination is determined in advance. In FIG. 5, the parameters are illustrated as A to I. For example, the distribution parameter corresponding to the combination of the customer group “1” and the first product group “3” is “A” (see FIG. 5). A set of the distribution parameters A to I determined in advance in this way is θ^{c,ich1}. As the distribution in each combination, for example, Gauss distribution, Poisson distribution, and the like may be appropriately used. In addition, as the distribution parameter, a mean, variance, and the like may be appropriately used, for example.

For example, it is assumed that a customer “c” belongs to the customer group “2”, and a product “i^{ch1}” in the first channel belongs to the first product group “3”. Hereupon, the distribution parameter “B” corresponding to the combination of the customer group “2” and the first product group “3” can be obtained from θ^{c,ich1} (see FIG. 5). In this way, when it is assumed that a customer belongs to a customer group, and a product in the first channel belongs to a first product group, the distribution parameter corresponding to the combination of the customer group and the first product group can be obtained from θ^{c,ich1}.

The above point also applies to θ^{c,ich2}. That is, for each combination of one customer group and one product group in the second channel, the distribution parameter of x_{c,ich2} according to the combination is determined in advance. A set of the distribution parameters is θ^{c,ich2}. When it is assumed that a customer belongs to a customer group, and a product in the second channel belongs to a second product group, the distribution parameter corresponding to the combination of the customer group and the second product group can be obtained from θ^{c,ich2}.

The likelihood described above can be expressed by the following Expression (1).

$$\begin{matrix}[ Mathematical Expression 1 ] & \\ {\prod }_{c ∈ {S}_{c}} ( {\prod }_{{i}^{ch 1} ∈ {S}_{1}} p ( {x}_{c , ich 1} \vert {θ}^{c , ich 1} , {z}_{c} , {z}_{ich 1} ) {\prod }_{{i}^{ch 2} ∈ {S}_{2}} p ( {x}_{c , ich 2} \vert {θ}^{c , ich 2} , {z}_{c} , {z}_{ich 2} ) ) & Expression ( 1 )\end{matrix}$$

In Expression (1), S_{c} is a set of the customer IDs, S₁ is a set of the product IDs in the first channel, and S₂ is a set of the product IDs in the second channel.

In addition, z_{c} represents a customer group to which the customer ID “c” belongs. Z_{ich1} represents a first product group to which the product ID “i^{ch1}” in the first channel belongs. Z_{ich2} represents a second product group to which the product ID “i^{ch2}” in the second channel belongs.

In this example, the grouping means 3 determines a group so that each of the customer IDs belongs to only one customer group, each of the product IDs in the first channel belongs to only one first product group, and each of the product IDs in the second channel belongs to only one second product group. In this case, such as z_{c}=2, z_{ich1}=3, z_{ich2}=4, z_{c} may represent the ID of the customer group, z_{ich1} may represent the ID of the first product group, and z_{ich2} may represent the ID of the second product group. At this time, z_{c} is a value of any of 1 to K^{c}. Similarly, z_{ich1} is a value of any of 1 to K^{ich1}, and z_{ich2} is a value of any of 1 to K^{ich2}.

In addition, for example, z_{c} may be represented by a vector in which only an element corresponding to the ID of the customer group is 1 and other elements are 0. For example, when the customer ID “4” belongs to the customer group “2”, by using a vector in which only the second element is 1 and the other elements are all 0, it may be represented as z_{c}=(0, 1, 0, 0, 0, . . . )^{T}. Incidentally, in this example, the suffix c in z_{c} is specifically 4.

Similarly, z_{ich1} may be represented by a vector in which only an element corresponding to the ID of the first product group is 1 and other elements are 0. For example, when the product ID “7” in the first channel belongs to the first product group “3”, by using a vector in which only the third element is 1 and other elements are all 0, it may be represented as z_{ich1}=(0, 0, 1, 0, 0, . . . )^{T}. Incidentally, in this example, the suffix ich1 in z_{ich1} is specifically 7. Similarly, z_{ich2} may be represented by a vector in which only an element corresponding to the ID of the second product group is 1 and other elements are 0.

In Expression (1), “θ_{c,ich1}, z_{c}, z_{ich1}” is a distribution parameter obtained from θ_{c,ich1} in accordance with a combination of z_{c}, z_{ich1}. Further, p(x_{c,ich1}|θ_{c,ich1}, z_{c}, z_{ich1}) is a probability that x_{c,ich1} occurs under the distribution parameter.

Similarly, in Expression (1), “θ_{c,ich2}, z_{c}, z_{ich2}” is a distribution parameter obtained from θ_{c,ich2} in accordance with a combination of z_{c}, z_{ich2}. Further, p(x_{c,ich2}|θ_{c,ich2}, z_{c}, z_{ich2}) is a probability that x_{c,ich2} Occurs under the distribution parameter.

As described above, when it is assumed that a customer belongs to a customer group, and a product in the first channel belongs to a first product group, the distribution parameter corresponding to the combination of the customer group and the first product group is obtained. In addition, from the number of products purchased x_{c,ich1} corresponding to the combination of the customer and the product, and the distribution parameter, p(x_{c,ich1}|θ_{c,ich1}, z_{c}, z_{ich1}) is obtained.

Similarly, when it is assumed that a customer belongs to a customer group, and a product in the second channel belongs to a second product group, the distribution parameter corresponding to the combination of the customer group and the second product group is obtained. From the number of products purchased x_{c,ich2} corresponding to the combination of the customer and the product, and the distribution parameter, p(x_{c,ich2}|θ_{c,ich2}, z_{c}, z_{ich2}) is obtained.

Therefore, by assuming the customer group to which each customer ID belongs, the first product group to which each product ID in the first channel belongs, and the second product group to which each product ID in the second channel belongs, the grouping means 3 can calculate the likelihood expressed by Expression (1). The grouping means 3 uses the likelihood to determine each of the customer group, the first product group, and the second product group.

For example, the grouping means 3 only needs to update the customer group to which each customer ID belongs, the first product group to which each product ID in the first channel belongs, and the second product group to which each product ID in the second channel belongs so that the likelihood obtained by calculation of Expression (1) increases, and determine each of the customer group, the first product group, and the second product group. In addition, for example, the grouping means 3 may update the customer group to which each customer ID belongs, the first product group to which each product ID in the first channel belongs, and the second product group to which each product ID in the second channel belongs, and determine each customer group, each first product group, and each second product group so that the likelihood obtained by calculation of Expression (1) becomes the maximum.

When updating the customer group, the first product group, and the second product group, the grouping means 3 may use the Gibbs sampling method that is one of the Markov Chain Monte Carlo (MCMC) algorithms. The MCMC algorithm is a technique based on sampling without using an approximation. In addition, the grouping means 3 may use the Expectation-Maximization (EM) method, the variational Bayesian method, or the like using an approximation, instead of the MCMC algorithm. When determining each customer group, each first product group, and each second product group so that the likelihood becomes the maximum, the grouping means 3 may use the EM method.

The grouping means 3 is realized by a CPU of a computer, for example. In this case, the CPU only needs to read a grouping program from a program recording medium such as a program storage device of the computer (not illustrated in FIG. 1), and operate as the grouping means 3 in accordance with the grouping program.

In addition, the grouping system may have a configuration in which two or more physically separated devices are connected together by wire or wirelessly. This point also applies to each exemplary embodiment described later.

Next, processing progress will be described. FIG. 6 depicts a flowchart illustrating an example of processing progress in the first exemplary embodiment of the present invention.

The combination of the customer, the product, and the history of the purchasing activity (in this example, the number of products purchased) obtained for each channel is input to the input means 2 by the administrator, for example (step S1). For example, the information exemplified in FIGS. 2(A) to 2(B) is input to the input means 2.

Next, the grouping means 3 uses the likelihood calculated by calculation of Expression (1) to determine the customer group, the first product group, and the second product group (step S2). Since operation of the grouping means 3 has already been described, the description thereof will be omitted here.

The grouping means 3 may display each group determined on, for example, a display device (not illustrated in FIG. 1). For example, the grouping means 3 may display on the display device the group and the element belonging to the group (in the present exemplary embodiment, the customer and the product) in association with each other, for each of the customer group, the first product group, and the second product group. This point also applies to other exemplary embodiments described later.

According to the present exemplary embodiment, the grouping means 3 uses the likelihood obtained by calculation of Expression (1) to simultaneously determine the customer group, the first product group, and the second product group. It can be said that such operation is operation for determining the customer group, the first product group, and the second product group, based on a relationship between the product and the customer, using an axis of the customer in common while distinguishing the channels. Therefore, even when the same customer takes different selection behavior for the same product depending on the channel, grouping of the products can be realized in the customer and each channel in consideration of such a change in a purchasing tendency due to the channel.

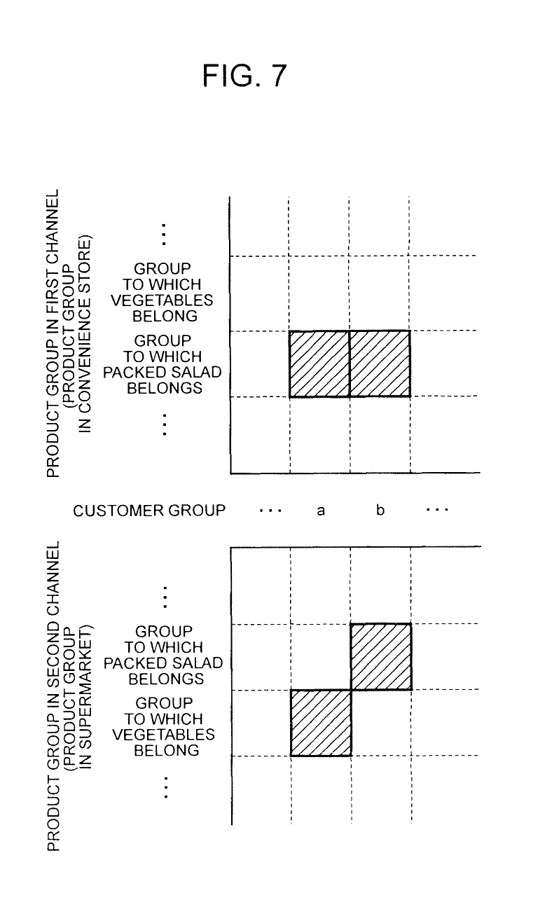

For example, it is assumed that there is a customer who purchases vegetables at a supermarket with a wide selection of products, and purchases a packed salad at a convenience store with a less selection of products. This customer is referred to as a customer A. In addition, it is assumed that there is a customer who purchases a packed salad at a supermarket and a convenience store. This customer is referred to as a customer B. According to the present invention, the customer group can be determined so that the customer A and the customer B belong to different customer groups, respectively. FIG. 7 depicts a schematic diagram illustrating a situation in which the customer A and the customer B are classified in different customer groups, respectively. The customer group “a” illustrated in FIG. 7 is a group to which the customer A belongs, and the customer group “b” is a group to which the customer B belongs. In addition, in FIG. 7, shaded areas indicate that the number of products purchased is large.

As a result, according to the present invention, a group of customers who purchase vegetables at a supermarket and purchase a packed salad at a convenience store, and a group of customers who purchase a packed salad at a supermarket and a convenience store can be determined as separate groups, respectively. Accordingly, an analyst can grasp a character of each customer group, and use it for future sales promotion and the like. For example, the analyst can perform characterization of “serious health consciousness” to the group of customers who purchase vegetables at a supermarket and purchase a packed salad at a convenience store, and perform characterization of “easy health consciousness” to the group of customers who purchase a packed salad at a supermarket and a convenience store.

Here, the customer who purchase vegetables and a packed salad has been described as an example; however, the grouping means 3 can determine a group of customers in which a product purchasing tendency in the first channel and a product purchasing tendency in the second channel are similar to each other, and a group of customers in which the product purchasing tendency in the first channel and the product purchasing tendency in the second channel are different from each other, as customer groups different from each other, respectively.

In this way, analysts of a retailer and a manufacturer can refer to each group determined by the grouping means 3 to accurately grasp customer's purchasing behavior different for each channel. As a result, the retailer and the manufacturer can recommend a product to the customer and present an advertisement of the product to the customer, depending on the channel. In addition, the retailer and the manufacturer can refer to an age, gender, excellence degree, and the like of the customer belonging to the customer group determined, to devise a marketing measure such as a product sales strategy depending on the channel.

Next, a modification of the present exemplary embodiment will be described. In the first exemplary embodiment, the case has been described where the grouping means 3 determines a group so that each of the customer IDs belongs to only one customer group, each of the product IDs in the first channel belongs to one first product group, and each of the product IDs in the second channel belongs to only one second product group. A method of determining the group is not limited to the above, and the grouping means 3 may determine each customer group, each first product group, and each second product group, allowing each of the customers (in other words, each of the customer IDs) to belong to one or more customer groups, each of the products (in other words, each of the product IDs) in the first channel belongs to one or more first product groups, and each of the products (in other words, each of the product IDs) in the second channel belongs to one or more second product groups. Also in this case, the grouping means 3 only needs to use the likelihood obtained by calculation of Expression (1) to determine each customer group, each first product group, and each second product group. The grouping means 3 may update the customer group, the first product group, and the second product group so that the likelihood increases, to determine those groups. Alternatively, the grouping means 3 may determine each customer group, each first product group, and each second product group so that the likelihood becomes the maximum. At this time, the grouping means 3 may use the Gibbs sampling method, the EM method, or the variational Bayesian method.

In addition, in the first exemplary embodiment, the case has been described where the number of channels is two as an example; however, the number of channels may be three or more. In the first exemplary embodiment, the case has been described where the first channel is the channel “a customer selects and purchases a product at a convenience store.”, and the second channel is the channel “a customer selects and purchases a product at a supermarket.”, as an example. Besides, as a channel, another channel may exist such as “a customer selects and purchases a product at a department store”. In that case, a combination of a customer, a product, and a history of a purchasing activity (for example, the number of products purchased) in the channel also only needs to be input to the input means 2. In addition, the grouping means 3 may use an expression also including elements corresponding to the third and subsequent channels, as an expression for calculating the likelihood. Also in this case, the grouping means 3 can determine each of the customer group and the group of products for each channel, using the customer as a common axis.

### Second Exemplary Embodiment

A grouping system of a second exemplary embodiment determines each of a group of customers, a group of products in a first channel, and a group of products in a second channel, and based on a result of the determination, determines a sales aspect according to the group of customers. Specifically, the grouping system of the second exemplary embodiment determines a product to be recommended to a customer, or determines a channel of when a designated product is sold to a customer. The grouping system of the present exemplary embodiment can also be referred to as a sales aspect determination system.

In the second exemplary embodiment, any channel is a channel depending on the store type.

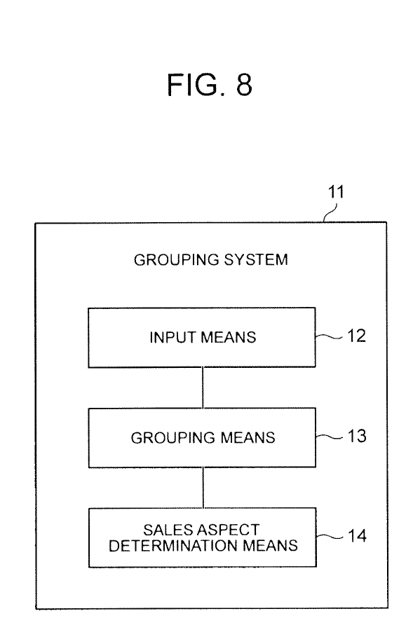

FIG. 8 depicts a block diagram illustrating an example of the grouping system of the second exemplary embodiment of the present invention. A grouping system 11 of the second exemplary embodiment includes an input means 12, a grouping means 13, and a sales aspect determination means 14.

The input means 12 is an input device that inputs a combination of a customer, a product, and a history that the customer has purchased the product, obtained for each channel. That is, the input means 12 inputs information exemplified in FIGS. 2(A) to 2(B), for example. In the present exemplary embodiment, a case will be described where the information indicating the history of the purchasing activity is the number of products purchased, both in the first channel and in the second channel, as an example. However, similarly to the first exemplary embodiment, the information indicating the history of the purchasing activity is not limited to the number of products purchased, and may be the purchasing amount of money, the price elasticity, or the like. It is assumed that Information calculated from each purchasing fact, such as the price elasticity, also corresponds to the information indicating the history of the purchasing activity.

In addition, similarly to the first exemplary embodiment, the first channel and the second channel are channels provided by one company having a sales channel via a plurality of channels.

In the following description, a case will be described where the first channel is a channel “a customer selects and purchases a product at a convenience store.”, and the second channel is a channel “a customer selects and purchases a product at a supermarket.”, as an example.

The grouping means 13 determines a customer group, a first product group (a group of products in the first channel), and a second product group (a group of products in the second channel), based on each combination of the customer, the product, and the history in each channel input to the input means 12.

The grouping means 13 may determine the customer group, the first product group, and the second product group with operation similar to that of the grouping means 3 in the first exemplary embodiment.

Alternatively, the grouping means 13 may determine each group with a method different from that of the first exemplary embodiment. For example, the grouping means 13 may determine the customer group, the first product group, and the second product group, without using the customer as a common axis.

In the following description, a case will be described where the grouping means 13 determines the customer group, the first product group, and the second product group with operation similar to that of the grouping means 3 in the first exemplary embodiment, as an example. When each group is determined with the operation similar to that of the first exemplary embodiment, the grouping means 13 determines a group of customers in which a product purchasing tendency in the first channel and a product purchasing tendency in the second channel are similar to each other, and a group of customers in which the product purchasing tendency in the first channel and the product purchasing tendency in the second channel are different from each other, as customer groups different from each other, respectively. For example, as exemplified in the first exemplary embodiment, the grouping means 13 determines a group of customers who purchase vegetables at a supermarket and purchase a packed salad at a convenience store, and a group of customers who purchase a packed salad at a supermarket and a convenience store, as separate customer groups, respectively.

The sales aspect determination means 14 determines a sales aspect according to the customer group, based on a determination result of the grouping means 13. In the example illustrated below, it is assumed that the sales aspect determination means 14 determines the product to be recommended to the customer.

To the sales aspect determination means 14, a customer ID, and a channel corresponding to a store in which a customer indicated by the customer ID currently exist are designated from, for example, an external system (not illustrated). For example, the external system acquires the customer ID and current position information from a mobile terminal possessed by the customer, and when determining that the customer exists in the store from the current position information, designates the customer ID, and the channel corresponding to the store, to the sales aspect determination means 14. Incidentally, the store is a convenience store or a supermarket managed by one company having sales channels respectively in the first channel and the second channel. For example, the external system, when determining that a customer exists in the convenience store, designates the customer ID of the customer and the first channel to the sales aspect determination means 14. In addition, for example, the external system, when determining that a customer exists in the supermarket, designates the customer ID of the customer and the second channel to the sales aspect determination means 14. In addition, the external system, even when a customer does not exist in the store, may determine a store (the convenience store or the supermarket managed by the company described above) closest to a current position of the customer (a current position of the mobile terminal), and designate the customer ID and the channel corresponding to the store to the sales aspect determination means 14.

The sales aspect determination means 14, when the customer ID and the channel are designated, for each combination of the customer group to which the customer belongs and each product group of the channel, obtains a statistic (for example, a mean value) of the history according to the combination, and based on the statistic, specifies a product group determined as being most likely to be purchased by the customer, and determines a product in the product group as a recommended product.

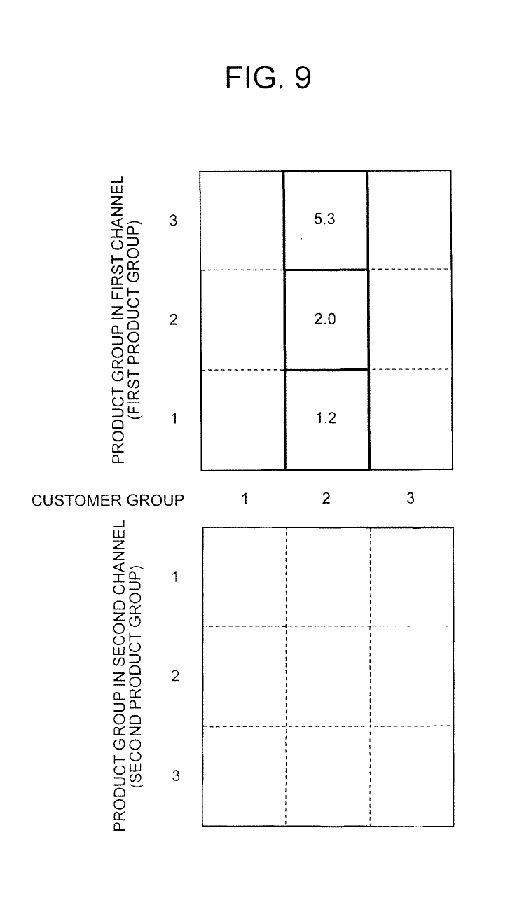

FIG. 9 depicts a schematic diagram illustrating a situation in which the sales aspect determination means 14 determines the recommended product. In FIG. 9, to simplify the description, a case is exemplified where each of the number of customer groups, the number of first product groups, and the number of second product groups is three. In addition, here, it is assumed that the first channel is designated. In addition, it is assumed that, as the history of the purchasing activity, the number of products purchased has been input to the input means 12. Further, it is assumed that the customer ID designated belongs to the customer group “2”.

The sales aspect determination means 14 specifies the customer group “2” to which the customer ID designated belongs. Since the first channel is designated, the sales aspect determination means 14 calculates a statistic (in this example, a mean value) of a history (the number of products purchased) x_{c,ich1}, for each combination of the customer group “2” and the first product groups “1” to “3”.

In the example illustrated in FIG. 9, the mean value of x_{c,ich1} is 1.2 in the combination of the customer group “2” and the first product group “1”, the mean value of x_{c,ich1} is 2.0 in the combination of the customer group “2” and the first product group “2”, and the mean value of x_{c,ich1} is 5.3 in the group of the customer group “2” and the first product group “3”. It can be said that the larger the mean value of the number of products purchased, the higher a probability that the customer purchases the product. Therefore, in this example, the sales aspect determination means 14 specifies the first product group “3” in which the mean value of the number of products purchased x_{c,ich1} is the largest in the customer group “2”. In this example, it can be said that the first product group “3” is the most suitable product group including a product most suitable for the recommended product. Further, the sales aspect determination means 14 determines a product belonging to the first product group “3” as a product to be recommended to the customer indicated by the customer ID designated. The sales aspect determination means 14 may determine all products belonging to the first product group “3” as the recommended products, or may determine some of the products as the recommended products. The sales aspect determination means 14 may determine any product belonging to the first product group “3” as the recommended product.

Further, the sales aspect determination means 14 transmits an advertisement of the recommended product to the customer's mobile terminal. A format of the advertisement may be a coupon, for example. In this case, it is sufficient that, for example, an administrator inputs a customer master including an address of the mobile terminal corresponding to each customer ID to the input means 12 so that the sales aspect determination means 14 can refer to the address of the mobile terminal corresponding to the customer ID.

The grouping means 13 and the sales aspect determination means 14 are realized by a CPU of a computer, for example. In this case, the CPU only needs to read a grouping program from a program recording medium such as a program storage device of the computer (not illustrated in FIG. 8), and operate as the grouping means 13 and the sales aspect determination means 14 in accordance with the grouping program. In addition, the grouping means 13 and the sales aspect determination means 14 may be realized by separate hardware devices, respectively.

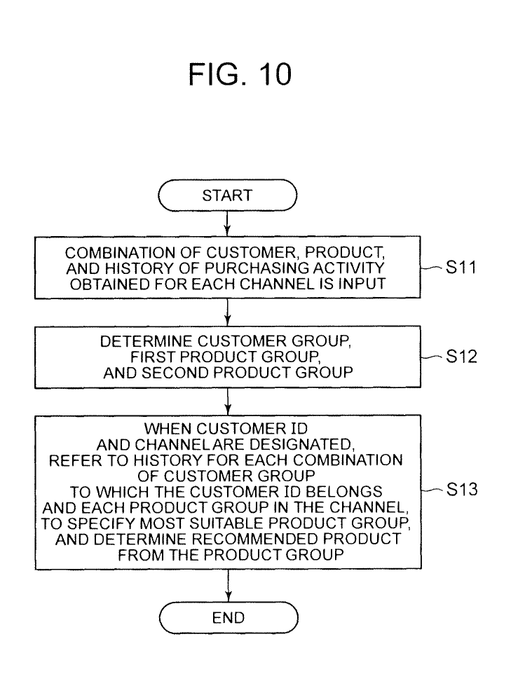

Next, processing progress will be described. FIG. 10 depicts a flowchart illustrating an example of processing progress in the second exemplary embodiment of the present invention.

The combination of the customer, the product, and the history of the purchasing activity (in this example, the number of products purchased) obtained for each channel is input to the input means 12 by the administrator, for example (step S11). Step S11 is similar to step S1 (see FIG. 6) in the first exemplary embodiment.

Next, the grouping means 13 determines the customer group, the first product group, and the second product group (step S12). The grouping means 13 determines each group with, for example, operation similar to that of the grouping means 3 in the first exemplary embodiment. However, the grouping means 13 may determine each group with another method.

Subsequently, when the customer ID and the channel are designated from the external system, the sales aspect determination means 14 refers to the history for each combination of the customer group to which the customer ID belongs and each product group in the channel, to specify the most suitable product group. Further, the sales aspect determination means 14 determines the product to be recommended to the customer indicated by the customer ID, from the product group (step S13). Further, the sales aspect determination means 14 transmits an advertisement of the recommended product to the customer's mobile terminal.

Since operation of the sales aspect determination means 14 in step S13 has already been described, a detailed description thereof will be omitted here.

With the operation described above, the product highly likely to be purchased by the customer can be accurately determined. As a result, an increase in a product sales volume can be expected.

In the above example, the case has been described where the sales aspect determination means 14 determines the recommended product, as an example of operation for determining the sales aspect. The operation for determining the sales aspect of the sales aspect determination means 14 is not limited to the above example. The sales aspect determination means 14, when the product and the customer are designated, may determine the channel of when the product is sold to the customer. Hereinafter, operation of the sales aspect determination means 14 in this case will be described.

For example, when the administrator determines to try to sell a product to a customer, the administrator designates the customer ID of the customer and the product ID of the product to the sales aspect determination means 14. The sales aspect determination means 14 accepts designation of the customer ID and the product ID.

Hereupon, the sales aspect determination means 14 specifies the customer group to which the customer ID belongs. In addition, the sales aspect determination means 14 specifies the first product group and the second product group to which the product ID belongs.

Further, the sales aspect determination means 14 obtains the statistic (for example, the mean value) of the history according to the combination of the customer group and the first product group specified, and similarly obtains the statistic of the history according to the combination of the customer group and the second product group specified. The sales aspect determination means 14 determines the channel of when the product designated is sold to the customer designated, by comparing the two statistics with each other.

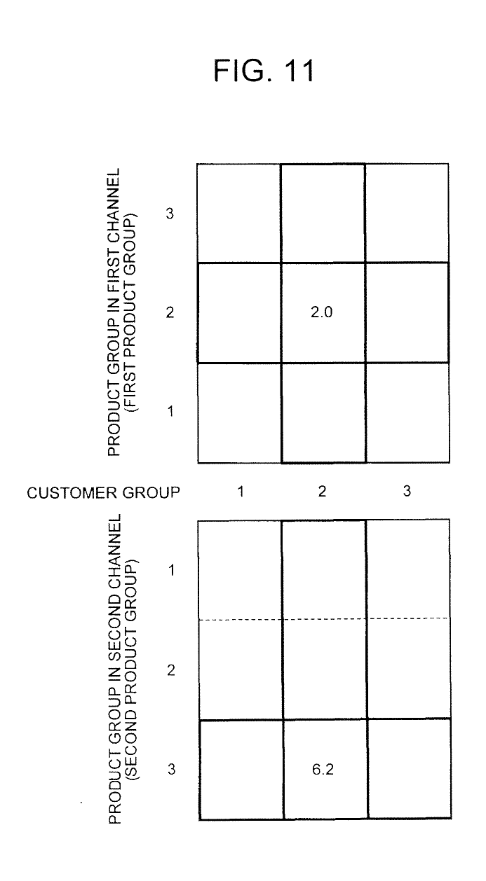

FIG. 11 depicts a schematic diagram illustrating a situation in which the sales aspect determination means 14 determines the channel. In FIG. 11, to simplify the description, a case is exemplified where each of the number of customer groups, the number of first product groups, and the number of second product groups is three. In addition, it is assumed that, as the history of the purchasing activity, the number of products purchased has been input to the input means 12. In addition, it is assumed that the customer ID designated belongs to the customer group “2”. It is assumed that the product ID designated belongs to the first product group “2” in the first product group, and belongs to the second product group “3” in the second product group.

The sales aspect determination means 14 specifies the customer group “2” to which the customer ID designated belongs. In addition, the sales aspect determination means 14 specifies each of the first product group “2” and the second product group “3” to which the product ID designated belongs.

The sales aspect determination means 14 calculates the statistic (in this example, the mean value) of the history (the number of products purchased) x_{c,ich1} corresponding to the combination of the customer group “2” and the first product group “2”, and similarly calculates the statistic of the history x_{c,ich2} corresponding to the combination of the customer group “2” and the second product group “3”.

In the example illustrated in FIG. 11, in the combination of the customer group “2” and the first product group “2”, the mean value of x_{c,ich1} is 2.0, and in the combination of the customer group “2” and the second product group “3”, the mean value of x_{c,ich2} is 6.2. It can be said that the larger the mean value of the number of products purchased, the higher a probability that the customer purchases the product. Therefore, in this example, it can be said that the probability that the customer purchases the product is higher when the product designated is tried to be sold to the customer in the second channel than when the product designated is tried to be sold to the customer in the first channel. Therefore, the sales aspect determination means 14 determines the second channel as a channel in which the product designated is sold to the customer designated. That is, the sales aspect determination means 14 determines to sell the product designated to the customer designated at the supermarket.

Incidentally, in the present exemplary embodiment, the channel is a channel depending on the store type. Therefore, determining the channel means determining the store type.

The sales aspect determination means 14 transmits an advertisement that recommends purchasing the product designated at the store of the type corresponding to the channel (in this example, the supermarket), to the mobile terminal of the customer designated. For example, the sales aspect determination means 14 transmits coupon information indicating that a discount is given when the product is purchased at the supermarket, to the mobile terminal of the customer. Incidentally, as described already, it is sufficient that, for example, the administrator inputs the customer master including the address of the mobile terminal corresponding to each customer ID to the input means 12 so that the sales aspect determination means 14 can refer to the address of the mobile terminal corresponding to the customer ID.

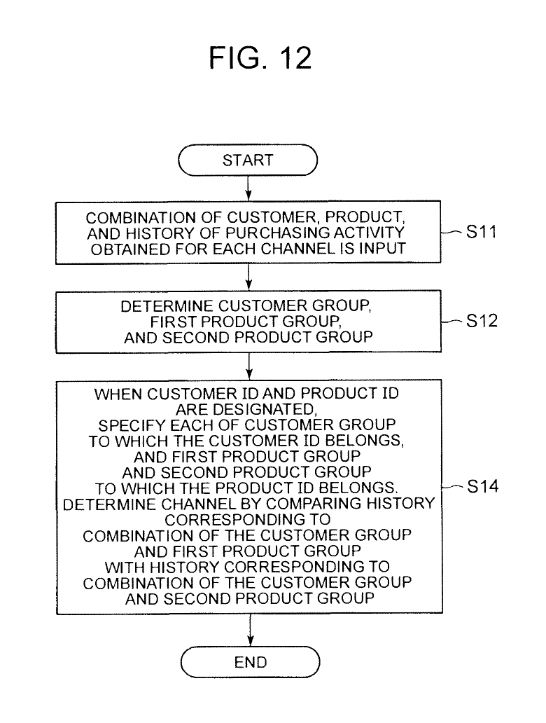

FIG. 12 depicts a flowchart corresponding to the above operation. Steps S11, S12 are similar to steps S11, S12 illustrated in FIG. 10, and the description thereof will be omitted.

After step S12, for example, when the customer ID and the product ID are designated from the administrator, the sales aspect determination means 14 specifies the customer group to which the customer ID belongs, and the first product group and the second product group to which the product ID belongs. Then, the sales aspect determination means 14 determines the channel by comparing the statistic of the history corresponding to the combination of the customer group and the first product group with the statistic of the history corresponding to the combination of the customer group and the second product group (step S14). Further, the sales aspect determination means 14 transmits the advertisement that recommends purchasing the product designated at the store of the type corresponding to the channel, to the mobile terminal of the customer designated.

With such operation, the channel (in other words, the store type) in which the probability that the customer designated purchases the product designated is higher can be specified. As a result, an increase in a product sales volume can be expected.

In the second exemplary embodiment, the sales aspect determination means 14 may perform both operation for determining the recommended product when the customer ID and the channel are designated, and operation for determining the channel when the customer ID and the product ID are designated.

### Third Exemplary Embodiment

In a third exemplary embodiment, an option in a customer's purchasing activity is an event. Specific examples of the event include, for example, a formal clothes sale, a casual clothes sale, an accessories sale, and a gifts sale, but are not limited thereto.

In addition, in the third exemplary embodiment, any channel is a channel depending on the information type of options (in the exemplary embodiment, the event). Examples of the channel in the third exemplary embodiment include “a customer who receives information of an event via direct mail goes to the event, and shops at the event.”, “a customer who receives information of an event via e-mail goes to the event, and shops at the event.”; however, the channel in the third exemplary embodiment is not limited thereto.

Incidentally, each channel is a channel provided by one company having a sales channel via a plurality of channels. This point is the same as each exemplary embodiment described above.

In the following description, a case will be described where a first channel is a channel “a customer who receives information of an event via direct mail goes to the event, and shops at the event.”, and a second channel is a channel “a customer who receives information of an event via e-mail goes to the event, and shops at the event.”, as an example. In this case, a group of options (events) in the first channel is a group of events that are informed to the customer via direct mail and at which the customer shops. Similarly, a group of options (events) in the second channel is a group of events that are informed to the customer via e-mail and at which the customer shops. However, the first channel and the second channel are not limited to the above examples.

A grouping system of the third exemplary embodiment determines each of a group of customers, a group of events in the first channel, and a group of events in the second channel. Then, the grouping system determines an event invitation aspect according to the group of customers, based on the group of customers, the group of events in the first channel, and the group of events in the second channel. Specifically, the grouping system determines an invitation aspect of a newly-held event in accordance with the group of customers. The invitation aspect is “invite via direct mail.”, “invite via e-mail.”, or the like, and corresponds to the channel. Therefore, the grouping system determines the event invitation aspect by determining the channel. The grouping system of the present exemplary embodiment can also be referred to as an event invitation aspect determination system.

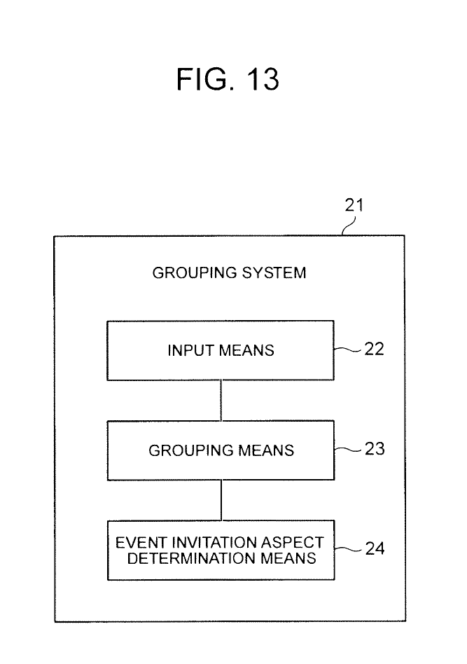

FIG. 13 depicts a block diagram illustrating an example of the grouping system in the third exemplary embodiment of the present invention. A grouping system 21 of the third exemplary embodiment includes an input means 22, a grouping means 23, and an event invitation aspect determination means 24.

The input means 22 is an input device that inputs a combination of a customer, an event, and a history of a purchasing activity of when the customer has been to the event, obtained for each channel. In the present exemplary embodiment, to simplify the description, a case will be described where the history of the purchasing activity is a purchasing amount of money of the customer at the event, both in the first channel and in the second channel, as an example. However, the history of the purchasing activity is not limited to the purchasing amount of money.

The grouping means 23 determines a customer group, a group of events in the first channel (hereinafter, referred to as a first event group), and a group of events in the second channel (hereinafter, referred to as a second event group), based on each combination of the customer, the event, and the purchasing amount of money in each channel input to the input means 22.

The grouping means 23 may determine the customer group, the first event group, and the second event group with operation similar to that of the grouping means 3 in the first exemplary embodiment. In the present exemplary embodiment, an option of the customer's purchasing activity is an event; however, the grouping means 23 can determine the customer group, the first event group, and the second event group with operation similar to that of the first exemplary embodiment.

Alternatively, the grouping means 23 may determine each group with a method different from that of the first exemplary embodiment. For example, the grouping means 23 may determine the customer group, the first event group, and the second event group, without using the customer as a common axis.

In the following description, a case will be described where the grouping means 23 determines the customer group, the first event group, and the second event group with operation similar to that of the grouping means 3 in the first exemplary embodiment, as an example. When determining each group with the operation similar to that of the first exemplary embodiment, the grouping means 23 determines a group of customers in which an event participation tendency in the first channel and an event participation tendency in the second channel are similar to each other, and a group of customers in which the event participation tendency in the first channel and the event participation tendency in the second channel are different from each other, as customer groups different from each other, respectively. For example, a group of customers who shop at a sale informed even when receiving the information of a formal clothes sale via direct mail and even when receiving the information of the formal clothes sale via e-mail, and a group of customers who shop at the sale when receiving the information of the formal clothes sale via direct mail but do not participate the sale when receiving the information of the formal clothes sale via e-mail, are determined as separate customer groups, respectively.

The event invitation aspect determination means 24 determines the event invitation aspect according to the customer group, based on a determination result of the grouping means 23.

For example, it is assumed that an administrator informs a customer of a newly-held event to invite the customer to the event. In this case, the administrator determines event groups to which the new event is regarded to belong from the first event group and the second event group, respectively. Then, the administrator designates respective IDs of the first event group and the second event group to which the new event is regarded to belong, and a customer ID of the customer to be tried to be invited, to the event invitation aspect determination means 24. The event invitation aspect determination means 24 accepts designation of the respective IDs of the first event group and the second event group to which the new event is regarded by the administrator to belong, and the customer ID.

The event invitation aspect determination means 24 specifies a customer group to which the customer ID designated belongs. Incidentally, the first event group and the second event group are directly designated by using the respective IDs.

Further, the event invitation aspect determination means 24 obtains a statistic (for example, a mean value) of the history (the purchasing amount of money) according to the combination of the customer group and the first event group specified, and similarly obtains a statistic of the history (the purchasing amount of money) according to the combination of the customer group and the second event group specified. The event invitation aspect determination means 24 determines the channel of when the customer indicated by the customer ID designated is invited to the new event, by comparing the two statistics with each other.

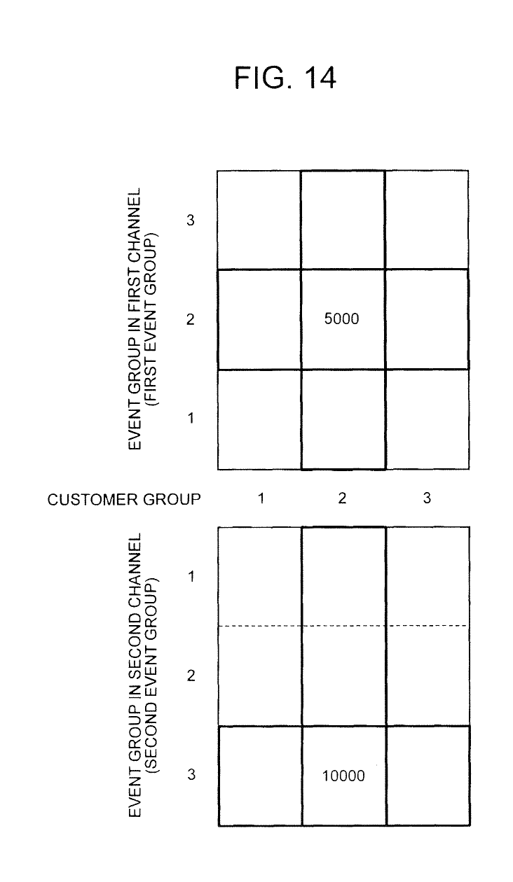

FIG. 14 depicts a schematic diagram illustrating a situation in which the event invitation aspect determination means 24 determines the channel. In FIG. 14, to simplify the description, a case is exemplified where each of the number of customer groups, the number of first event groups, and the number of second event groups is three. In addition, it is assumed that the customer ID designated belongs to the customer group “2”. In addition, it is assumed that the ID of the first event group to which the new event is regarded by the administrator to belong is “2”, and the ID of the second event group to which the new event is regarded by the administrator to belong is “3”.

The event invitation aspect determination means 24 specifies the customer group “2” to which the customer ID designated belongs.

The event invitation aspect determination means 24 calculates a mean value of a purchasing amount of money x_{c,ich1} corresponding to the combination of the customer group “2” and the first event group “2” designated, and similarly calculates a mean value of a purchasing amount of money x_{c,ich2} corresponding to the combination of the customer group “2” and the second event group “3” designated.

In the example illustrated in FIG. 14, the mean value of x_{c,ich1} is 5000 in the combination of the customer group “2” and the first event group “2”, and the mean value of x_{c,ich2} is 10000 in the combination of the customer group “2” and the second event group “3”. It can be said that the larger the mean value of the purchasing amount of money, the higher a probability that the customer comes to the event to shop. Therefore, in this example, it can be said that, when the customer is invited to the new event and the customer is prompted to shop, the probability that the customer comes to the event to shop is higher in the second channel than in the first channel. Therefore, the event invitation aspect determination means 24 determines the second channel as a channel of when the customer designated is invited to the new event and the customer is prompted to shop. It can be said that this determination is to send the information of the event via e-mail.

The grouping means 23 and the event invitation aspect determination means 24 are realized by a CPU of a computer, for example. In this case, the CPU only needs to read a grouping program from a program recording medium such as a program storage device of the computer (not illustrated in FIG. 13), and operate as the grouping means 23 and the event invitation aspect determination means 24 in accordance with the grouping program. In addition, the grouping means 23 and the event invitation aspect determination means 24 may be realized by separate hardware devices, respectively.

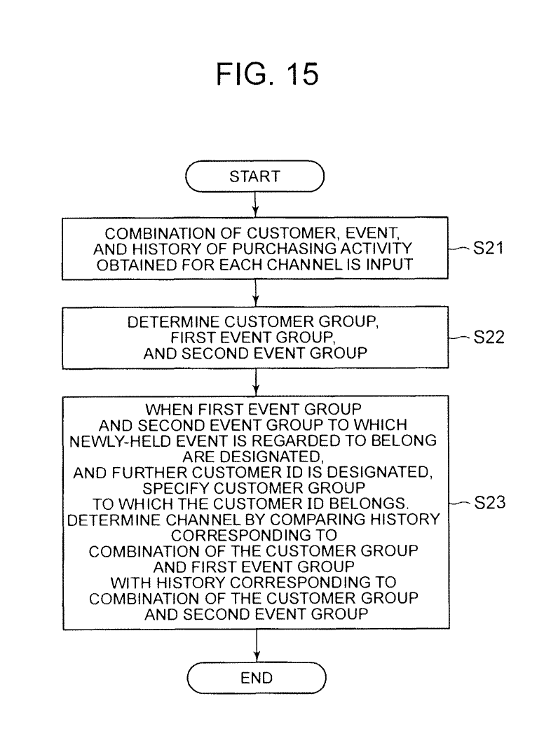

FIG. 15 depicts a flowchart illustrating an example of processing progress in the third exemplary embodiment of the present invention.

The combination of the customer, the event, and the history of the purchasing activity (in this example, the purchasing amount of money of when the customer has shopped at the event) obtained for each channel is input to the input means 22 by the administrator, for example (step S21).

Next, the grouping means 23 determines the customer group, the first event group, and the second event group (step S22). The grouping means 23 determines each group with, for example, operation similar to that of the grouping means 3 in the first exemplary embodiment. However, the grouping means 23 may determine each group with another method.

Subsequently, when the first event group and the second event group to which the newly-held event is regarded by the administrator to belong are designated by using the respective IDs and further the customer ID is designated, the event invitation aspect determination means 24 specifies the customer group to which the customer ID belongs. Then, the event invitation aspect determination means 24 determines the channel by comparing the statistic of the history corresponding to the combination of the customer group and the first event group designated with the statistic of the history corresponding to the combination of the customer group and the second event group designated (step S24). Since the channel corresponds to the invitation aspect of the event, it can be said that step S24 is operation for determining the invitation aspect of the event.

With such operation, the event invitation aspect can be specified in which the probability that the customer designated participates the new event to shop is higher. Then, by inviting the customer to the event with the event invitation aspect, an increase in sales amount in the event can be expected.

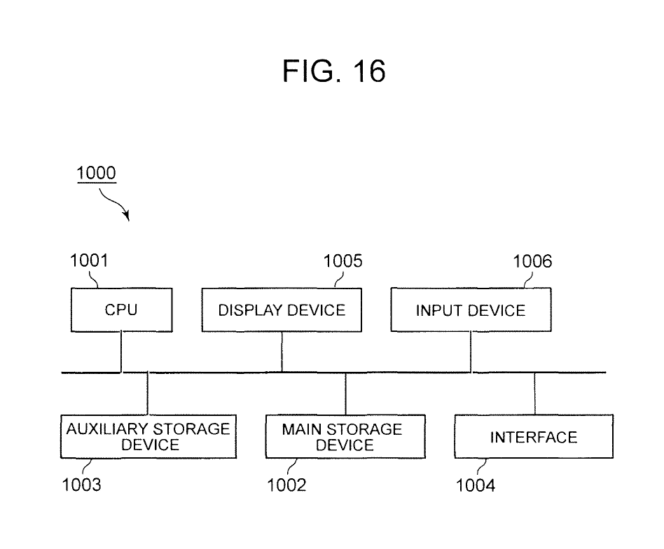

FIG. 16 depicts a schematic block diagram illustrating a configuration example of a computer according to each exemplary embodiment of the present invention. A computer 1000 includes a CPU 1001, a main storage device 1002, an auxiliary storage device 1003, an interface 1004, a display device 1005, and an input device 1006.

The grouping system of each exemplary embodiment is implemented in the computer 1000. Operation of the grouping system is stored in the auxiliary storage device 1003 in a format of a program (grouping program). The CPU 1001 reads the program from the auxiliary storage device 1003, and deploys the program on the main storage device 1002, and then executes the processing described above in accordance with the program.

The auxiliary storage device 1003 is an example of a non-transitory tangible medium. Other examples of the non-transitory tangible medium include a semiconductor memory, DVD-ROM, CD-ROM, a magneto-optical disk, and a magnetic disk connected via the interface 1004. In addition, when the program is delivered to the computer 1000 through a communication line, the computer 1000 receiving the delivery may deploy the program on the main storage device 1002 and execute the processing described above.

In addition, the program may be the one for partially realizing the processing described above. Further, the program may be a differential program that realizes the processing described above in combination with another program already stored in the auxiliary storage device 1003.

Each exemplary embodiment described above can also be described as the following supplementary notes but are not limited thereto.

(Supplementary note 1) A grouping system including: an input means that inputs a combination of a customer, an option of an activity, and a history of the activity, obtained for each channel being an aspect in which the customer selects the option of the activity; and a grouping means that uses a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

(Supplementary note 2) The grouping system according to supplementary note 1, wherein the grouping means determines the group of customers, the group of options in the first channel, and the group of options in the second channel such that each of the customers belongs to only one group, each of the options in the first channel belongs to only one group, and each of the options in the second channel belongs to only one group.

(Supplementary note 3) The grouping system according to supplementary note 1, wherein the grouping means determines the group of customers, the group of options in the first channel, and the group of options in the second channel, allowing each of the customers to belong to one or more groups, each of the options in the first channel belongs to one or more groups, and each of the options in the second channel belongs to one or more groups.

(Supplementary note 4) The grouping system according to any one of supplementary notes 1 to 3, wherein the option of the activity is a product being an option of a purchasing activity.

(Supplementary note 5) A grouping system including: an input means that inputs combinations of a customer, a product, and a history that the customer has purchased the product, obtained for each channel being an aspect in which a customer selects a product; a grouping means that determines a group of customers, a group of products in a first channel, and a group of products in a second channel, based on each combination input to the input means; and a sales aspect determination means that determines a sales aspect according to the group of customers, based on a determination result of the grouping means.

(Supplementary note 6) The grouping system according to supplementary note 5, wherein the grouping means determines a group of customers in which a product purchasing tendency in a first channel and a product purchasing tendency in a second channel are similar to each other, and a group of customers in which a product purchasing tendency in the first channel and a product purchasing tendency in the second channel are different from each other, as groups different from each other, respectively.

(Supplementary note 7) The grouping system according to supplementary note 5 or 6, wherein the sales aspect determination means, when a customer and a channel are designated, determines a product to be recommended for the customer, based on a group of customers to which the customer belongs and groups of products in the channel.

(Supplementary note 8) The grouping system according to any one of supplementary notes 5 to 7, wherein the sales aspect determination means, when a customer and a product are designated, determines a channel of when the product is sold to the customer, based on a group of customers to which the customer belongs, a group to which the product belongs in the first channel, and a group to which the product belongs in the second channel.

(Supplementary note 9) A grouping system including: an input means that inputs combinations of a customer, an event, and a history that the customer has participated in the event, obtained for each channel being an aspect in which the customer selects the event; a grouping means that determines a group of customers, a group of events in a first channel, and a group of events in a second channel, based on each combination input to the input means; and an event invitation aspect determination means that determines an event invitation aspect according to the group of customers, based on a determination result of the grouping means.

(Supplementary note 10) The grouping system according to supplementary note 9, wherein the grouping means determines a group of customers in which an event participation tendency in a first channel and an event participation tendency in a second channel are similar to each other, and a group of customers in which the event participation tendency in the first channel and the event participation tendency in the second channel are different from each other, as groups different from each other, respectively.

(Supplementary note 11) The grouping system according to supplementary note 9 or 10, wherein the event invitation aspect determination means, when a group of events in the first channel and a group of events in the second channel each regarded by an administrator as including a newly-held event and a customer are designated, determines a channel of when the customer is invited to the event, based on a group of customers to which the customer belongs, the group of events in the first channel, and the group of events in the second channel.

(Supplementary note 12) A grouping method including: accepting an input of combinations of a customer, an option of an activity, and a history of the activity, obtained for each channel being an aspect in which the customer selects the option of the activity; and using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

(Supplementary note 13) A grouping method including: accepting an input of combinations of a customer, a product, and a history that the customer has purchased the product, obtained for each channel being an aspect in which a customer selects a product; determining a group of customers, a group of products in a first channel, and a group of products in a second channel, based on each combination; and determining a sales aspect according to the group of customers, based on a determination result.

(Supplementary note 14) A grouping method including: accepting an input of combinations of a customer, an event, and a history that the customer has participated in the event, obtained for each channel being an aspect in which the customer selects the event; determining a group of customers, a group of events in a first channel, and a group of events in a second channel, based on each combination; and determining an event invitation aspect according to the group of customers, based on a determination result.

(Supplementary note 15) A grouping program installed in a computer including an input means that inputs combinations of a customer, an option of an activity, a history of the activity, obtained for each channel being an aspect in which the customer selects the option of the activity, the grouping program for causing the computer to execute: grouping processing for using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

(Supplementary note 16) A grouping program installed in a computer including an input means that inputs combinations of a customer, a product, and a history that the customer has purchased the product, obtained for each channel being an aspect in which a customer selects a product, the grouping program for causing the computer to execute: grouping processing for determining a group of customers, a group of products in a first channel, and a group of products in a second channel, based on each combination input to the input means; and sales aspect determination processing for determining a sales aspect according to the group of customers, based on a determination result of the grouping processing.

(Supplementary note 17) A grouping program installed in a computer including an input means that inputs combinations of a customer, an event, a history that the customer has participated in the event, obtained for each channel being an aspect in which the customer selects the event, the grouping program for causing the computer to execute: grouping processing for determining a group of customers, a group of events in a first channel, and a group of events in a second channel, based on each combination input to the input means; and event invitation aspect determination processing for determining an event invitation aspect according to the group of customers, based on a determination result of the grouping processing.

(Supplementary note 18) A sales aspect determination system including: an input means that inputs combinations of a customer, a product, and a history that the customer has purchased the product, obtained for each channel being an aspect in which a customer selects a product; a grouping means that classify customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to the input means; and a sales aspect determination means that determines different sales aspects for a sales aspect for a customer belonging to the first customer group and a sales aspect for a customer belonging to the second customer group, respectively.

(Supplementary note 19) A sales aspect determination method including: accepting an input of combinations of a customer, a product, and a history that the customer has purchased the product, obtained for each channel being an aspect in which a customer selects a product; and classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination; and determining different sales aspects for a sales aspect for a customer belonging to the first customer group and a sales aspect for a customer belonging to the second customer group, respectively.

(Supplementary note 20) A sales aspect determination program that is a grouping program installed in a computer including an input means that inputs combinations of a customer, a product, and a history that the customer has purchased the product, obtained for each channel being an aspect in which a customer selects a product, the sales aspect determination program for causing the computer to execute: grouping processing for classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to an input means; and sales aspect determination processing for determining different sales aspects for a sales aspect for a customer belonging to the first customer group and a sales aspect for a customer belonging to the second customer group, respectively.

(Supplementary note 21) An event invitation aspect determination system including: an input means that inputs combinations of a customer, an event, and a history that the customer has participated in the event, obtained for each channel being an aspect in which the customer selects the event; a grouping means that classify customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input means; and an event invitation aspect determination means that determines different event invitation aspects for an event invitation aspect for a customer belonging to the first customer group and an event invitation aspect for a customer belonging to the second customer group, respectively.

(Supplementary note 22) An event invitation aspect determination method including: accepting an input of combinations of a customer, an event, and a history that the customer has participated in the event, obtained for each channel being an aspect in which the customer selects the event; classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination; and determining different event invitation aspects for an event invitation aspect for a customer belonging to the first customer group and an event invitation aspect for a customer belonging to the second customer group, respectively.

(Supplementary note 23) An event invitation aspect determination program that is a grouping program installed in a computer including an input means that inputs combinations of a customer, an event, a history that the customer has participated in the event, obtained for each channel being an aspect in which the customer selects the event, the event invitation aspect determination program for causing the computer to execute: grouping processing for classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input means; and event invitation aspect determination processing for determining different event invitation aspects for an event invitation aspect for a customer belonging to the first customer group and an event invitation aspect for a customer belonging to the second customer group, respectively.

In the above, the present invention has been described with reference to the exemplary embodiments; however, the present invention is not limited to the exemplary embodiments described above. Various modifications that can be understood by those skilled in the art within the scope of the present invention can be made to the configuration and details of the present invention.

This application claims priority based on Japanese Patent Application No. 2015-032841 filed on Feb. 23, 2015, the disclosure of which is incorporated herein in its entirety.

### INDUSTRIAL APPLICABILITY

The present invention is suitably applied to a grouping system that groups customers together and groups options of an activity for a customer together.

### REFERENCE SIGNS LIST

1, 11, 21 Grouping system
2, 12, 22 Input means
3, 13, 23 Grouping means
14 Sales aspect determination means
24 Event invitation aspect determination means

1. A grouping system comprising:
an input unit, implemented by an input device, that inputs combinations of a customer, an option of an activity, and a history of the activity, obtained for each channel being an aspect in which the customer selects the option of the activity; and
a grouping unit, implemented by a processor, that uses a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

2. The grouping system according to claim 1, wherein
the grouping unit determines the group of customers, the group of options in the first channel, and the group of options in the second channel such that each of the customers belongs to only one group, each of the options in the first channel belongs to only one group, and each of the options in the second channel belongs to only one group.

3. The grouping system according to claim 1, wherein
the grouping unit determines the group of customers, the group of options in the first channel, and the group of options in the second channel, allowing each of the customers to belong to one or more groups, each of the options in the first channel belongs to one or more groups, and each of the options in the second channel belongs to one or more groups.

4. The grouping system according to claim 1, wherein
the option of the activity is a product being an option of a purchasing activity.

5. A sales aspect determination system comprising:
an input unit, implemented by an input device, that inputs combinations of a customer, a product, and a history that the customer has purchased the product, obtained for each channel being an aspect in which a customer selects a product;
a grouping unit, implemented by a processor, that classify customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to the input unit; and
a sales aspect determination unit, implemented by the processor, that determines different sales aspects for a sales aspect for a customer belonging to the first customer group and a sales aspect for a customer belonging to the second customer group, respectively.

6. The sales aspect determination system according to claim 5, wherein
the sales aspect determination unit recommends different content items for an item to be recommended for a customer belonging to the first customer group and an item to be recommended for a customer belonging to the second customer group, respectively, for the product belonging to the product group of interest.

7. The sales aspect determination system according to claim 5, wherein
the sales aspect determination unit, when a customer and a channel are designated, determines a product to be recommended for the customer, based on a group of customers to which the customer belongs and groups of products in the channel.

8. The sales aspect determination system according to claim 5, wherein
the sales aspect determination unit, when a customer and a product are designated, determines a channel of when the product is sold to the customer, based on a group of customers to which the customer belongs, a group to which the product belongs in the first channel, and a group to which the product belongs in the second channel.

9. An event invitation aspect determination system comprising:
an input unit, implemented by an input device, that inputs combinations of a customer, an event, and a history that the customer has participated in the event, obtained for each channel being an aspect in which the customer selects the event;
a grouping unit, implemented by a processor, that classify customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input unit; and
an event invitation aspect determination unit, implemented by the processor, that determines different event invitation aspects for an event invitation aspect for a customer belonging to the first customer group and an event invitation aspect for a customer belonging to the second customer group, respectively.

10. The event invitation aspect determination system according to claim 9, wherein
the event invitation aspect determination unit, when a group of events in the first channel and a group of events in the second channel each regarded by an administrator as including a newly-held event and a customer are designated, determines a channel of when the customer is invited to the event, based on a group of customers to which the customer belongs, the group of events in the first channel, and the group of events in the second channel.

11. A grouping method comprising:
accepting an input of combinations of a customer, an option of an activity, and a history of the activity, obtained for each channel being an aspect in which the customer selects the option of the activity; and
using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

12. A sales aspect determination method comprising:
accepting an input of combinations of a customer, a product, and a history that the customer has purchased the product, obtained for each channel being an aspect in which a customer selects a product; and
classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination; and
determining different sales aspects for a sales aspect for a customer belonging to the first customer group and a sales aspect for a customer belonging to the second customer group, respectively.

13. An event invitation aspect determination method comprising:
accepting an input of combinations of a customer, an event, and a history that the customer has participated in the event, obtained for each channel being an aspect in which the customer selects the event;
classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination; and
determining different event invitation aspects for an event invitation aspect for a customer belonging to the first customer group and an event invitation aspect for a customer belonging to the second customer group, respectively.

14. A non-transitory computer-readable recording medium in which a grouping program is recorded, the grouping program installed in a computer including an input unit that inputs combinations of a customer, an option of an activity, a history of the activity, obtained for each channel being an aspect in which the customer selects the option of the activity,
the grouping program for causing the computer to execute:
grouping processing for using a likelihood of a group of customers, a group of options in a first channel, and a group of options in a second channel, calculated based on a distribution parameter of a history of the activity according to a combination of the group of customers and the group of options in the first channel, a history of the activity in the first channel, a distribution parameter of a history of the activity according to a combination of the group of customers and the group of options in the second channel, and a history of the activity in the second channel, to determine the group of customers, the group of options in the first channel, and the group of options in the second channel.

15. A non-transitory computer-readable recording medium in which a sales aspect determination program is recorded, the sales aspect determination program installed in a computer including an input unit that inputs combinations of a customer, a product, and a history that the customer has purchased the product, obtained for each channel being an aspect in which a customer selects a product,
the sales aspect determination program for causing the computer to execute:
grouping processing for classifying customers into a plurality of groups including a first customer group in which a product purchasing tendency in a first channel and a product purchasing tendency in a second channel are similar to each other for a product group of interest, and a second customer group in which the product purchasing tendency in the first channel and the product purchasing tendency in the second channel are different from each other for the product group of interest, based on each combination input to an input unit; and
sales aspect determination processing for determining different sales aspects for a sales aspect for a customer belonging to the first customer group and a sales aspect for a customer belonging to the second customer group, respectively.

16. A non-transitory computer-readable recording medium in which an event invitation aspect determination program is recorded, the event invitation aspect determination program installed in a computer including an input unit that inputs combinations of a customer, an event, and a history that the customer has participated in the event, obtained for each channel being an aspect in which the customer selects the event,
the event invitation aspect determination program for causing the computer to execute:
grouping processing for classifying customers into a plurality of groups including a first customer group in which an event participation tendency in a first channel and an event participation tendency in a second channel are similar to each other for an event group of interest, and a second customer group in which the event participation tendency in the first channel and the event participation tendency in the second channel are different from each other for the event group of interest, based on each combination input to the input unit; and
event invitation aspect determination processing for determining different event invitation aspects for an event invitation aspect for a customer belonging to the first customer group and an event invitation aspect for a customer belonging to the second customer group, respectively.
